(19) United States
(12) Patent Application Publication
(10) Pub. No.: US 2026/0183616 A1
(43) Pub. Date: Jul. 2, 2026

(54) Sports Player Prediction and Evaluation System

(71) Applicant: JFM International Corp,, Miami, FL (US)

(72) Inventors: Yanwei Liu, Miami, FL (US); Philip Lauren, Miami, FL (US)

(21) Appl. No.: 19/438,548

(22) Filed: Dec. 31, 2025

Related U.S. Application Data
(60) Provisional application No. 63/741,011, filed on Dec. 31, 2024.

(51) Int. Cl. A63B 24/00

(52) U.S. Cl. CPC A63B 24/0062; A63B 2024/0068

(57) ABSTRACT

A sports player prediction and evaluation system with embedded node architecture collecting, analyzing, and generating fused player data sets from evaluation sessions having a plurality of analysis rounds. Parameters and data are continuously and cumulatively identified, collected, updated, and saved in a database. Past data are used for comparative purposes to evaluate player progress and to predict future player outcomes.

### CROSS REFERENCE TO RELATED APPLICATION

This U.S. non-provisional application claims the benefit of U.S. provisional application No. 63/741,011 filed on Dec. 31, 2024, entitled Sports Player Prediction and Evaluation System, the entire contents of which are herein incorporated by reference.

### FIELD OF THE DISCLOSURE

The present disclosure relates to systems and methods for a system with artificial intelligence system trained with machine learning and used in connection with a plurality of sensors to observe, predict, and evaluate player performance in various sport games involving an object and at least one player.

### BACKGROUND OF THE DISCLOSURE

Athletic performance demands and athletic abilities are increasingly more competitive. Athletes, referees, observers, sports wagerers, and coaches are increasingly relying on technology enhancements and tools to make player and game evaluations, predictions, and for skill and strategy feedback.

Artificial intelligence-assisted technologies are increasing in popularity. However, many AI systems are inadequate and fail to consider human behavior, human error, individual human characteristics, and individual environmental factors that will influence a player or game outcome.

In addition, many training and performance evaluation systems are inaccurate or are imprecise.

### SUMMARY OF THE DISCLOSURE

What is needed are systems and methods for player and sports predictions and outcome analysis. This architecture provides several technical advantages, including reduced latency in multi-node data fusion, improved accuracy through dynamic sensitivity and classification adjustments, enhanced robustness to environmental variation, and scalable synchronization across heterogeneous nodes. Continuous comparison against cumulative historical datasets further increases predictive reliability and training optimization. The system delivers real-time performance tracking and behavior modeling with greater precision and adaptability than static or single-source evaluation platforms.

In one embodiment, A real-time, networked evaluation system is composed of multiple sensor-equipped nodes that collect environmental, motion, and behavioral data from players and objects. Each node contains an independent embedded system and communicates bi-directionally with a central local server—referred to as the hivemind—via wired, wireless, or power-over-fiber connections.

In one embodiment during an evaluation session, all nodes are initialized and calibrated before entering a baseline analysis round followed by multiple consecutive analysis rounds. In each round, nodes adjust detection or sensor parameters, and the hivemind updates algorithmic settings. Nodes synchronize their software algorithms with the hivemind. Session data—including player positions, real-world distance metrics, and probability distributions of game outcomes—is stored in various player, team, or sport profiles.

In one embodiment, nodes transmit parameter data to the hivemind. The hivemind analyzes these data to identify player and object behaviors and forwards the processed information to an AI module. The AI module determines baseline parameters or detects parameter shifts across rounds. When shifts occur, both hivemind algorithms and node-level detection/sensor algorithms adjust sensitivity, speed thresholds, movement direction tracking, object/player classification, dimensional assumptions, or environmental compensations.

In one embodiment, analysis occurs continuously in real time. Each round produces algorithmic updates or maintain existing settings to optimize player training. The system compares incoming data to cumulative historical datasets—standardized, training, comparative, or from prior evaluation sessions—to track individual player performance, compare multiple players, and generate predictive performance insights. Results are transmitted to and displayed on a graphical user interface.

### BRIEF DESCRIPTION OF THE DRAWINGS

The accompanying drawings that are incorporated in and constitute a part of this specification illustrate various embodiments of the disclosure. Together with the description, the drawings serve to explain the principles of the disclosure.

FIG. 1 shows a schematic of an exemplary system.

FIG. 2 shows a schematic of an evaluation session with a plurality of analysis rounds.

FIG. 3 shows a diagram of an exemplary sensor arrangement on a playing field with player and object targets.

FIG. 4 shows exemplary data analysis and performance results method steps.

FIG. 5 shows a diagram of an exemplary subsystem structure.

### NUMERALS OF THE FIGURES

1 system
3 hivemind
5 bidirectional wireless transmission
7 AI module
9 node
11 data collection device
13 evaluation session
15 analysis round
17 database
19 player 1
21 player 2
23 player 3
24 player n
25 object
27 goal
29 field
31 sampling system
33 analysis system
35 central processing unit

### DETAILED DESCRIPTION

The present disclosure provides generally for AI systems with a plurality of sensors for data capture and analysis pertaining to sports player and game predictions, outcomes, or performance skill feedback. A real-time evaluation system utilizes a network of sensor-equipped nodes to collect environmental, motion, and behavioral data from players and objects. Each node includes an embedded system that communicates bi-directionally with a central local server (“hivemind”) via wired, wireless, or power-over-fiber connections. During an evaluation session, nodes are initialized and calibrated, followed by a baseline round and multiple analysis rounds. The hivemind analyzes incoming parameter data and provides processed results to an AI module that identifies baseline conditions or detects parameter shifts. Based on detected changes, node-level detection parameters and hivemind algorithms may dynamically adjust sensitivity, speed thresholds, movement tracking, classification, and environmental compensations. The system performs continuous real-time analysis, compares current data to cumulative historical datasets, and generates performance tracking, comparative assessments, and predictive insights for individual players or groups, with results stored in associated profiles and displayed via a graphical interface. Unlike conventional fixed-parameter systems, the disclosed architecture performs iterative analysis rounds in which both node-level detection parameters and hivemind algorithms automatically adjust based on AI-identified parameter shifts. The system continuously compares live data to cumulative historical datasets to generate individualized performance tracking, cross-player comparisons, and predictive insights. This closed-loop, multi-node, real-time adaptation enables responsive training optimization and behavior modeling not achievable with static or single-source evaluation systems.

In the following sections, detailed descriptions of examples and methods of the disclosure will be given. The description of both preferred and alternative examples is exemplary only, and it is understood that to those skilled in the art that variations, modifications, and alterations may be apparent. It is therefore to be understood that the examples do not limit the broadness of the aspects of the underlying disclosure as defined by the claims.

### DETAILED DESCRIPTIONS OF THE DRAWINGS

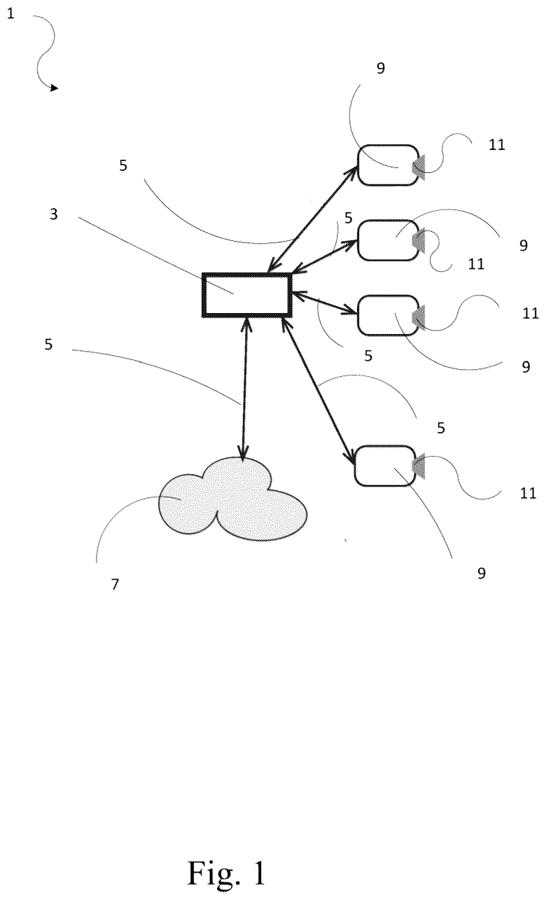

Referring now to FIG. 1, A schematic of an exemplary system is shown. Most notable is the bi-directional flow of data in a real-time embedded system whereby environmental data and motion data of objects and of players is collected and transmitted. Each data collection device has a node. A plurality of devices with nodes forms a network connected to a local server that receives data pertaining to object and player movement. Each node has an independent embedded system connected to a local server, the hivemind, through wired connection, power over fiber connection, or wireless connection. The local server may be connected to the Internet wirelessly or through a wired connection.

Each node may incorporate one or more motion sensors such as accelerometers, gyroscopes, magnetometers, or full inertial measurement units sampling at rates between 50 and 2000 Hz. Nodes may further include optical sensors such as CMOS camera modules capable of capturing still images or video at resolutions ranging from 720p to 4K, as well as audio sensors such as directional or omnidirectional microphones. Environmental sensors may also be integrated to measure temperature, humidity, barometric pressure, ambient light, or wind conditions. Each node may be powered by a microcontroller or microprocessor, such as an ARM Cortex-M7 or Cortex-A53, with associated RAM and non-volatile memory for local processing and buffering. Communication between nodes and the central server, referred to as the hivemind, may occur through Wi-Fi, Bluetooth Low Energy, wired Ethernet, or power-over-fiber connections. Nodes may include a real-time clock to support timestamping and synchronization across the network.

The hivemind server may be implemented as a local computing system equipped with CPU and GPU resources sufficient to perform real-time data fusion and AI inference. The server may include high-speed network interfaces such as 1-10 Gbps Ethernet or Wi-Fi 6, as well as solid-state or NVMe storage for maintaining cumulative historical datasets. In some embodiments, the hivemind may include a clock synchronization module to maintain sub-millisecond alignment across all nodes. The hivemind may also interface with cloud-based systems for remote access, long-term storage, or additional computational resources.

Each node executes embedded firmware that preprocesses raw sensor data by filtering noise, normalizing values, and extracting local features such as acceleration peaks or optical flow vectors. The node packages this information into timestamped frames and transmits the frames to the hivemind at a configurable rate, which may range from 10 to 120 Hz depending on the application. Nodes also receive algorithmic updates from the hivemind, allowing them to adjust detection thresholds, sensitivity levels, or classification parameters in response to changing conditions.

The hivemind processes incoming data through a multi-stage pipeline. First, the hivemind ingests timestamped frames from all nodes and aligns them using clock correction and interpolation. It then performs sensor fusion by combining IMU data, optical data, audio data, and environmental measurements to generate unified state estimates for players, objects, or environmental conditions. The hivemind identifies behaviors or movement patterns, evaluates current parameter values against baseline or historical datasets, and determines whether a parameter shift has occurred. When a shift is detected, the hivemind communicates updated detection or sensitivity parameters back to the nodes. The hivemind also forwards processed data to an AI module for higher-level inference.

An AI module may include machine learning models such as convolutional neural networks for classification, regression models for estimating speed or trajectory, anomaly detection models for identifying deviations from expected behavior, or reinforcement learning models for optimizing training recommendations. These models may be trained using historical session data, synthetic datasets, standardized movement libraries, or player-specific calibration data. An AI module may determine whether a parameter shift has occurred by detecting deviations from baseline values, reductions in classification confidence, changes in environmental conditions, or significant differences between current and historical movement patterns.

Parameters used by the system may include sensitivity thresholds, speed thresholds, movement direction vectors, classification labels, dimensional assumptions, and environmental compensation factors. A parameter shift may be detected when a measured value deviates from baseline by more than a predetermined threshold, when classification confidence drops below a threshold, when environmental conditions change significantly, or when movement patterns differ from historical data. When a parameter shift is detected, the system may adjust node-level detection settings or hivemind-level algorithms to maintain accuracy and responsiveness.

The system may store data in structured profiles. A player profile may include a unique identifier, physical attributes, historical performance metrics, movement signatures, training recommendations, and probability distributions of predicted outcomes. Session data may include raw node data, fused multi-node data, parameter values, detected parameter shifts, AI inference results, and training adjustments. These datasets may be stored cumulatively to support long-term performance tracking and predictive modeling.

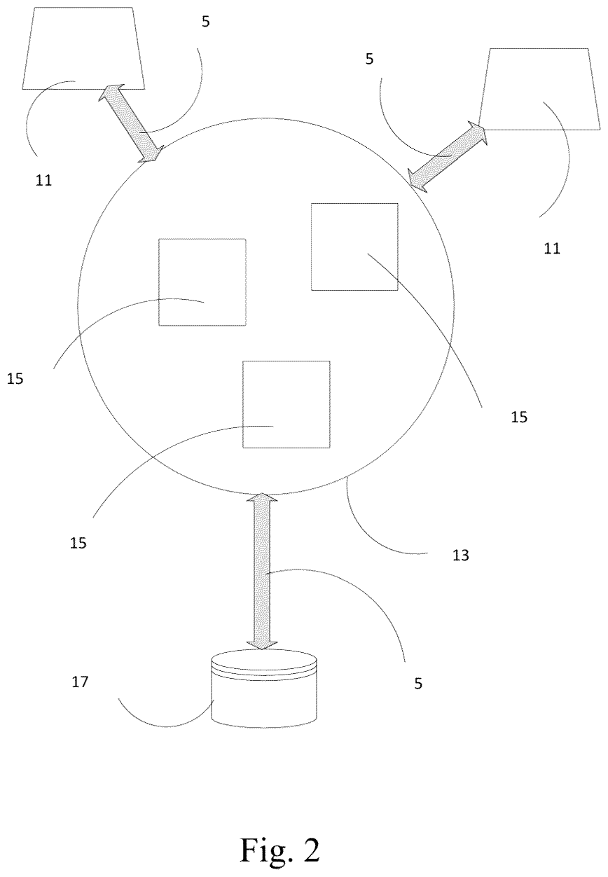

Referring now to FIG. 2, an evaluation session with a plurality of analysis rounds is shown. In each evaluation session, each node is initialized by powering on, and data parameters are calibrated. An evaluation session typically involves a baseline round followed by a plurality of consecutive analysis rounds. Each analysis round may trigger a detection or sensor parameter shift. Each analysis round may trigger an algorithmic shift. Parameters may include player positions, at least one pixel providing real-world distance and relative position for each node in a field. Each node connects to the hivemind and synchronizes programmatic software algorithms for each node. The probability distribution of the game result, and improvement details for each player may be stored in a database in a player profile, game or sport profile, or team profile, or time period profile.

After initial synchronization and calibration, at least one node may transmit parameter data such as environmental data, photographic, video, audio, or movement data to the hivemind in a baseline round of analysis. Parameter data input from each node is analyzed in the hivemind to identify player and object behaviors. The analyzed data is transmitted from the hivemind to an AI module. The analyzed data is processed by AI module algorithms to determine a parameter baseline in a first round of analysis or to determine a parameter shift in a second or subsequent round of analysis. If the parameter input data triggers a change in parameter input value, then analysis algorithms in the hivemind and detection or sensor algorithms in the node may adjust for sensitivity, speed, movement direction, player or object type, player or object dimensions, and environment conditions.

Analyses are continuous in real time with each analysis round resulting in an algorithmic adjustment or an algorithmic continuation to optimize a player training program. Each round may also result in a node detection or sensor shift. The input parameter data may be compared against past data which is standardized, training, comparative, or data generated from a past evaluation session. Past data are cumulative. Past data are stored and accessed in a database and may be saved to be used for future evaluation sessions. Data is specific to each player and may be used to track player performance or may be used to compare performance between multiple players. Cumulative player history data can be combined for analysis of future performance predictions. Results and data are transmitted and displayed on a graphical user interface.

In one embodiment, the system detects a parameter shift when a player's peak acceleration decreases by more than fifteen percent relative to a baseline value calculated from at least ten prior sessions. For example, if a player typically produces a peak acceleration of eight meters per second squared, a sustained drop below approximately 6.8 meters per second squared for several consecutive sprints causes the hivemind to adjust detection sensitivity and modify training recommendations. A similar shift may occur when a player's average sprint speed over a ten-second interval deviates by more than 1.5 meters per second from the established baseline, prompting the system to update tracking frequency and classification thresholds. The system may also monitor cadence, and when a player's step frequency changes by more than ten percent relative to a baseline cadence maintained for at least thirty seconds, the hivemind identifies a parameter shift and updates movement classification parameters accordingly. Rapid changes in direction may also trigger adjustments; for instance, when a player's movement vector rotates by more than forty-five degrees within a two-hundred-millisecond window, the system increases the sampling rate of motion sensors and optical tracking resolution for a short period to capture the event with higher fidelity.

Optical and spatial parameters may also trigger shifts. In one example, the system maintains a calibration in which a single pixel corresponds to approximately two centimeters at a given distance. When the estimated pixel-to-distance mapping deviates by more than ten percent—such as when a calibration object known to be one meter in length appears to be less than ninety centimeters or more than one hundred ten centimeters—the system initiates an automatic recalibration of the affected camera model. Tracking confidence may also serve as a trigger; when the confidence score for a player's position estimate falls below 0.7 for more than half a second, the hivemind increases reliance on IMU data and adjusts fusion weights to compensate for reduced optical reliability. In multi-node configurations, a parameter shift may be detected when two or more nodes report the same player's position with a discrepancy greater than half a meter for several consecutive frames, causing the system to recalibrate node alignment and synchronization parameters.

Environmental conditions may also influence parameter shifts. When ambient light levels measured at a node change by more than twenty percent within a five-second interval, the system adjusts camera exposure, image-processing gain, and classification thresholds to maintain accuracy under new lighting conditions. Temperature changes may also be relevant; when the ambient temperature shifts by more than five degrees Celsius relative to the baseline measured at the start of the session, the system may adjust model parameters that depend on sensor drift or player physiology and may alter recommended training intensity.

AI-based thresholds provide another mechanism for detecting parameter shifts. The AI module may assign a confidence score between zero and one for each classification event, and when the confidence for a particular class falls below 0.6 for more than ten consecutive frames, the system may switch to a more conservative model, increase the size of the data window used for inference, or request additional sensor input from nearby nodes. Anomaly detection models may also identify shifts when a feature vector lies more than 2.5 standard deviations from the baseline mean, prompting the system to modify event-detection thresholds or flag potential injury or abnormal behavior.

Temporal thresholds may also be used. When end-to-end processing latency between node acquisition and hivemind decision exceeds eighty milliseconds for more than one second, the system detects a parameter shift and reduces nonessential computation, lowers video resolution, or decreases frame rate to restore real-time performance. A similar shift may occur when a node fails to transmit data for more than five hundred milliseconds, causing the hivemind to reweight remaining nodes, interpolate missing data, or mark the node as temporarily degraded.

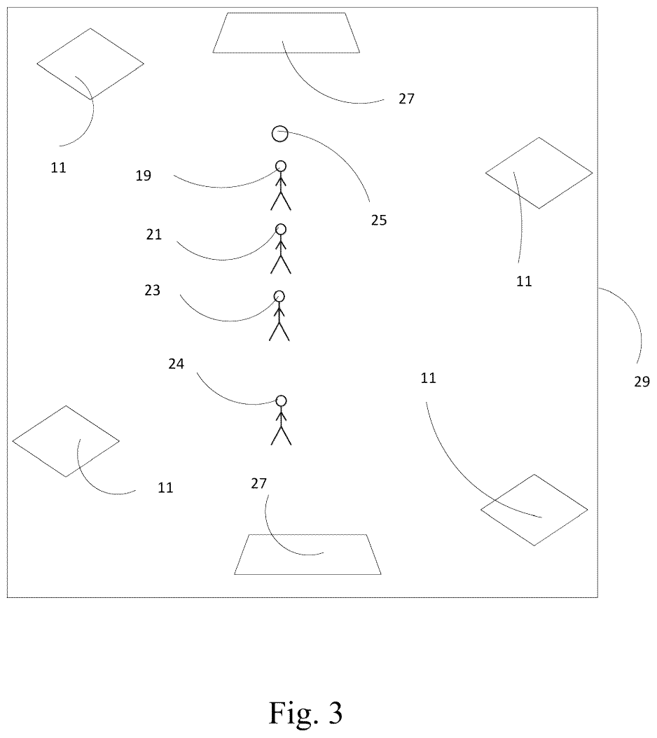

Referring now to FIG. 3, a diagram of an exemplary sensor arrangement on a playing field with players and object targets is shown. Systems include data capture devices such as fixed/mobile devices with high-resolution, high-speed cameras and condition sensors including, but not limited to temperature, relative humidity, airflow, air pressure, GPS, altitude, etc. The devices will be in the field and connected to general AI to synchronize and analyze behavior in real-time. The entire system can project the outcomes of a game using the data gathered. Example applications include multiple professional/nonprofessional sports, including, but not limited to golf, tennis, basketball, baseball, soccer, football, and volleyball.

In some embodiments, a system may include a data collection device with node that is mobile such as connected to or integrated into a drone, a vehicle, a dolly, or any other mobile device. Mobile data collection devices may be used in conjunction with stationary data collection devices.

In one embodiment, the system is deployed as a multi-node soccer training platform in which eight nodes are positioned around a soccer field. Each node includes a 1080p camera, a 9-axis IMU, a microphone, and a Wi-Fi 6 communication module. During a training session, the nodes are powered on and calibrated, and a baseline round captures lighting conditions, field geometry, and initial player positions. During subsequent analysis rounds, the hivemind detects that a particular player's acceleration patterns deviate from baseline, and the AI module identifies this deviation as a parameter shift associated with fatigue. The system automatically adjusts node sensitivity thresholds to maintain accurate tracking and generates a recommendation to reduce the player's training load.

In another embodiment, the system is used as an indoor basketball performance analyzer. Four ceiling-mounted nodes capture high-frame-rate video at 120 frames per second, IMU data from wearable sensors, and environmental data such as temperature and humidity. The hivemind fuses optical and IMU data to track jump height, lateral movement, and shooting mechanics. The AI module compares current performance to cumulative historical data and predicts improvement trends, enabling personalized training recommendations.

In a further embodiment, the system is used for object tracking in a robotics training environment. Nodes mounted around a robotics testing arena track robot arm movement, object trajectories, and environmental disturbances. When the AI module detects that the robot's movement deviates from expected patterns, the system identifies a parameter shift and triggers recalibration of node detection parameters to maintain accurate tracking.

In yet another embodiment, the system performs multi-player comparative analysis. Nodes track two or more players simultaneously, and the hivemind fuses multi-node data to generate comparative metrics. The system computes probability distributions of future performance and identifies differences in reaction time, movement efficiency, or improvement rates. These insights allow the system to generate individualized training recommendations for each player.

During operation, each node continuously acquires raw sensor data and transmits timestamped data frames to the hivemind. As an example, consider a training session in which a player begins a sprint across the monitored field. The node closest to the player captures high-frame-rate video showing the player's initial acceleration, while a second node positioned at a different angle captures the same motion with slightly different lighting and perspective. At the same time, an IMU-equipped wearable on the player's torso transmits acceleration and rotational velocity data. Each node preprocesses its respective data by filtering noise, normalizing values, and extracting preliminary features such as optical flow vectors, acceleration peaks, and direction-of-motion estimates. These preprocessed frames are then transmitted to the hivemind for fusion.

Upon receiving the data, the hivemind aligns the frames using timestamp correction and interpolation to ensure that all sensor inputs correspond to the same moment in time. The hivemind then performs sensor fusion by combining the optical flow vectors from the camera nodes with the acceleration and gyroscopic data from the IMU. Through this fusion process, the hivemind generates a unified estimate of the player's instantaneous velocity, direction of movement, and body orientation. The hivemind compares these fused values to baseline parameters stored in the player's historical profile. For example, if the player's baseline acceleration curve typically peaks at eight meters per second squared within the first half-second of a sprint, the hivemind evaluates whether the current acceleration curve deviates significantly from that expected pattern.

The hivemind then forwards the fused data and preliminary analysis to the AI module. The AI module may include a trained neural network configured to classify movement patterns and detect anomalies. The neural network receives the fused feature vector—containing acceleration magnitude, direction changes, stride frequency, optical flow magnitude, and environmental context—and produces a classification output indicating whether the player's movement corresponds to a normal sprint, a fatigued sprint, a misstep, or an unexpected behavior. The AI module also produces a confidence score for each classification. If the confidence score for the “normal sprint” class falls below a predetermined threshold, such as 0.6, the AI module determines that a parameter shift has occurred.

In this example, suppose the AI module identifies that the player's acceleration curve is fifteen percent lower than the baseline and that the stride frequency is ten percent slower than expected. The AI module interprets these deviations as indicators of fatigue. The module then generates an instruction set for the hivemind, specifying that node-level detection sensitivity should be increased to compensate for reduced motion intensity. The hivemind transmits updated parameters to the nodes, causing the optical sensors to increase exposure time and the IMU filters to lower their acceleration thresholds so that subtle movements remain detectable.

Simultaneously, the AI module updates the player's performance profile by storing the detected parameter shift, the fused motion data, and the classification results. The system may also generate a predictive assessment indicating that the player's performance is trending downward relative to historical data. This prediction may be displayed on a graphical interface along with recommended training adjustments.

Through this process, the system continuously evaluates incoming data, identifies deviations from expected behavior, and adapts both node-level and server-level algorithms in real time. The combination of sensor fusion, baseline comparison, AI-driven classification, and dynamic parameter adjustment enables the system to maintain high accuracy and responsiveness under changing conditions.

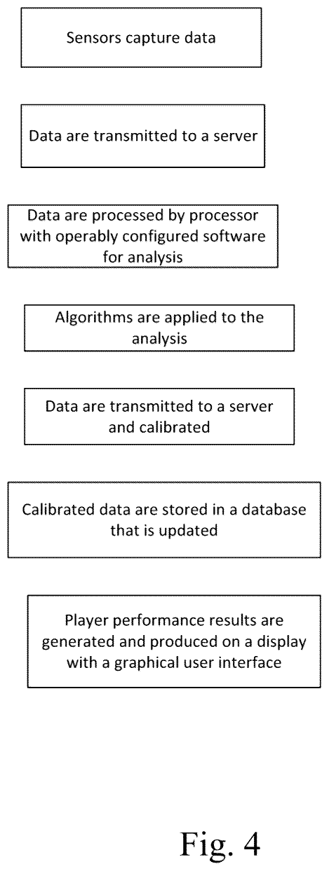

Referring now to FIG. 4, exemplary data analysis and performance results method steps are shown. The steps represent general processes. In general, movement analysis using multiple devices through AI, while considering weather factors, to dissect professional sports players' motion and provide possible performance improvements. The architecture provides sensor-fusion advantages including reduced noise through cross-node corroboration, improved spatial and temporal resolution from multi-modal data alignment, enhanced robustness to occlusion or sensor dropout, and more accurate classification of player and object behaviors through combined environmental and kinematic inputs. Continuous comparison against cumulative historical datasets further strengthens predictive modeling and training optimization. The system delivers high-precision, real-time performance analysis that exceeds the capabilities of single-sensor or non-adaptive platforms.

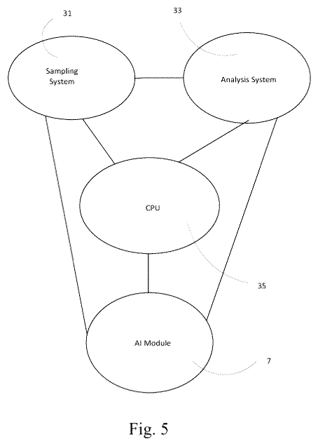

Referring now to FIG. 5, an exemplary subsystem structure is shown. A sampling system may contain data collection devices with nodes, sensors, cameras, GPS, GIS, wireless receives and transmitters, mobile devices, or any data collection or capture device. An analysis system may comprise a factor matrix, at least one general AI algorithm. Post-game resolution and other analytical functions are contemplated. A general AI graphical user interface shown in a display contains general AI and user interfaces. A CPU may comprise communications, networks, processors, operably configured software, and dynamic software with programmatic instructions.

Embedded systems as a node allow the baseline algorithms to be fixed and data subsequently adjusted. For example, the projection of sports objects (ball for instance) is decided by gravity, air flow (wind), air temperature, air humidity. These baseline parameters and consequently algorithms are decided or determined by the laws of physics and fluid dynamics. Changes in algorithms, due to the updated collected data from an analysis round, for example, location for gravity, air pressure, temperature, humidity for its viscosity, air flow (wind) may change the course of the sports objects (balls) moving course. Player information such as weight, height, limb length, jump height, punching or hitting force, or bat or racket swing speed may also be loaded from a player profile database and synchronized with each node in the embedded system.

### Conclusion

A number of embodiments of the present disclosure have been described. While this specification contains many specific implementation details, this specification should not be construed as limitations on the scope of any disclosures or of what may be claimed. The specification presents descriptions of features specific to particular embodiments of the present disclosure.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. Nevertheless, it will be understood that various modifications may be made without departing from the spirit and scope of the claimed disclosure.

What is claimed is:

1. A player performance and evaluation system, comprising:
a plurality of nodes, each node comprising an embedded processor and at least one sensor configured to collect parameter data;
a communication interface configured to enable bi-directional data exchange between the plurality of nodes and a local server;
the local server comprising a processor configured to receive timestamped parameter data from the plurality of nodes, to synchronize the parameter data across the plurality of nodes, and to perform sensor fusion to generate fused behavioral data representing movement or behavior of at least one player or object;
an artificial intelligence module in communication with the local server and configured to analyze the fused behavioral data to determine a baseline parameter or to detect a parameter shift relative to the baseline parameter; and
wherein, in response to detecting the parameter shift, the local server is further configured to transmit an updated detection parameter or algorithmic parameter to at least one of the plurality of nodes, such that the at least one node adjusts a detection threshold, sensitivity level, classification parameter, dimensional assumption, or environmental compensation used during subsequent acquisition of parameter data.

2. A method of implementing the system of claim 1, comprising:
receiving, at each of a plurality of nodes, parameter data preprocessing, at each node, the parameter data to generate timestamped data frames;
transmitting, from the plurality of nodes to a local server, the timestamped data frames via a bi-directional communication interface;
synchronizing, at the local server, the timestamped data frames received from the plurality of nodes;
performing, at the local server, sensor fusion on the synchronized data frames to generate fused behavioral data representing movement or behavior of at least one player or object;
analyzing, at an artificial intelligence module in communication with the local server, the fused behavioral data to determine a baseline parameter or to detect a parameter shift relative to the baseline parameter;
determining, based on the detected parameter shift, an updated detection parameter or algorithmic parameter; and
transmitting, from the local server to at least one of the plurality of nodes, the updated detection parameter or algorithmic parameter such that the at least one node adjusts a detection threshold, sensitivity level, classification parameter, dimensional assumption, or environmental compensation used during subsequent acquisition of parameter data.
